(19) United States
(12) Patent Application Publication
(10) Pub. No.: US 2005/0146222 A1
(43) Pub. Date: Jul. 7, 2005

(54) Direct current portable power supply

(76) Inventor: Richard M. Hulden, Taylors, SC (US)

Correspondence Address: DORITY & MANNING, P.A., POST OFFICE BOX 1449, GREENVILLE, SC, 29602-1449, US

(21) Appl. No.: 10/368,263

(22) Filed: Feb. 17, 2003

Related U.S. Application Data
(60) Provisional application No. 60/359,617, filed on Feb. 26, 2002.

(51) Int. Cl. H02J 7/00

(52) U.S. Cl. 307/66

(57) ABSTRACT

A portable direct current power supply for being connected to the terminals of an electrical device comprises a battery surrounded by a case and a pair of electric cables, each cable being electrically connected to one of the terminals of the battery. The power supply includes a pair of manually detachable electric connectors, each having a feed end electrically connected to one end of one of the cables and having a gripping end disposed opposite the feed end and configured to detachably grip at least one of the terminals of the electric device that is to be powered. Each of the connectors carries a light source that is disposed thereon so as to illuminate beyond the free end of the connector. Each light source can be electrically connected so as to be powered by the battery or a separate battery can be provided and carried on the connector. The power supply includes a digital read-out voltage meter carried by the case and electrically connected to the terminals of the battery. A switch is carried by the case and electrically connected to control activation of the voltage meter so that the operator can select between the numerical display indicating the voltage output of the battery or the voltage output of the electrical device that is connected to the battery by the cables and connectors. The power supply further desirably includes an elastomeric cover overlying the exterior surface of the case and configured to cushion the case from mechanical shocks to the case. The cover can include a skid-resistant surface that is configured and disposed for resting the power supply on foreign objects.

### CROSS-REFERENCE TO RELATED APPLICATIONS

The present application claims priority to currently pending U.S. Provisional Patent Application No. 60/359,617, filed Feb. 26, 2002

### STATEMENT REGARDING FEDERALLY SPONSORED RESEARCH OR DEVELOPMENT

N/A

### BACKGROUND OF THE INVENTION

The present invention relates to direct current power supplies and more particularly to direct current power supplies that are portable.

Portable direct current power supplies are known and have many uses. One typical use is for starting cars with dead batteries. The portability of such power supplies enables the vehicle owner to store the power supply in the vehicle. If the power supply must be connected under darkened conditions, a lone operator may have difficulty seeing the battery's terminals where the connectors at the ends of the cables of the power supply need to be connected. If the poor visibility causes the operator to connect the cable of the power supply to the wrong terminal of the battery, a dangerous condition will result. If the operator has a flashlight, one hand can direct light from the flashlight while the other hand holds the alligator clip that is used to attach one of the cables of the power supply to one of the terminals of the dead battery. However, this arrangement also can prove sufficiently cumbersome so as to result in the wrong connection and thereby present a dangerous condition to the operator.

The portability of the power supply likewise enables a roadside mechanic to transport the power supply to a vehicle that is disabled on the road. Such power supplies typically have an analog gauge that provides the operator with a reading of the voltage output of the power supply. When a lone operator is trying to jump start a dead battery, the operator's line of sight to the gauge can be less than ideal for accurately reading such gauge, especially in low light conditions.

Many vehicles nowadays have systems that continuously draw power from the vehicle's battery and require a certain minimum battery voltage for operation of the system. For example, if the output of the vehicle's battery drops below a certain threshold voltage, then some vehicles are programmed to disable the transmission, thereby rendering the vehicle immobile. A roadside mechanic who succeeds in using the portable power supply to jump start the engine of a vehicle with a dead battery, must check the battery's voltage output to determine whether it is above the threshold voltage needed to operate such systems as the transmission noted above. The roadside mechanic must carry a voltmeter to accomplish this task. When a mechanic encounters such a situation of insufficient voltage in the battery of a vehicle disabled on the roadside, it becomes desirable to leave the power supply connected to the battery so that the transmission will detect a voltage above the threshold voltage, and the vehicle can be driven to the repair shop rather than towed to the shop. In such situations, the mechanic may rest the power supply beneath the vehicle's hood and atop the engine and close the hood down on top of the power supply to hold it in place while the vehicle is being moved back to the repair shop. Unfortunately, during the trip back to the repair shop, the power supply sometimes shifts position atop the engine and in doing so can cause damage to the engine and/or to the power supply.

### OBJECTS AND SUMMARY OF THE INVENTION

It is a principal object of the present invention to provide direct current power supplies that are portable and that address and at least partially overcome the problems and difficulties noted above.

Additional objects and advantages of the invention will be set forth in part in the description that follows, and in part will be obvious from the description, or may be learned by practice of the invention. The objects and advantages of the invention may be realized and attained by means of the instrumentalities and combinations particularly pointed out in the appended claims.

To achieve the objects and in accordance with the purpose of the invention, as embodied and broadly described herein, a portable direct current power supply that is suitable for being connected to the terminals of an electrical device comprises a battery surrounded by a case. A first electric cable is electrically connected to one of the terminals of the battery, and a second electric cable is electrically connected to the other one of the terminals of the battery. The power supply includes a pair of manually detachable electric connectors. Each connector has a feed end electrically connected to one end of one of the cables and has a gripping end disposed opposite the feed end and configured to detachably grip at least one of the terminals of the electric device that is to be powered.

In accordance with the present invention, each of the connectors carries a light source that is disposed thereon so as to illuminate beyond the free end of the connector. Desirably, this light source includes a light-emitting diode. Each light source can be electrically connected so as to be powered by the battery inside the case. Alternatively, a separate small battery receptacle can be provided and carried on each connector to receive a small battery, such as a triple A battery, to power each light source.

In further accordance with the present invention, the power supply includes a digital read-out voltage meter that is carried by the case and electrically connected to the terminals of the battery. A switch is carried by the case and electrically connected to control activation of the voltage meter. The switch is configured and electrically connected so that the operator can manually operate the switch to select between the numerical display indicating the voltage output of the battery or the voltage output of the electrical device that is connected to the battery by the cables and connectors.

In still further accordance with the present invention, the power supply further desirably includes an elastomeric cover that overlies the exterior surface of the case. The cover desirably overlies substantially the entire exterior surface of the case. The cover is configured to cushion the case from mechanical shocks to the case. The cover can be selectively removable from the case so as to permit changing of the battery carried within the case. Alternatively, the cover can be permanently molded into the exterior surface of the case. The cover desirably includes a skid-resistant surface that is configured and disposed for resting the power supply on foreign objects.

The accompanying drawings, which are incorporated in and constitute a part of this specification, illustrate a presently preferred embodiment of the invention as well as some alternative embodiments. These drawings, together with the description, serve to explain the principles of the invention but by no means are intended to be exhaustive of all of the possible manifestations of the invention.

### BRIEF DESCRIPTION OF THE DRAWINGS

FIG. 1 is an elevated perspective view of a presently preferred embodiment of the invention;

FIG. 2A is an elevated perspective view of a component of a presently preferred embodiment of the invention;

FIG. 2B is an elevated perspective view of another embodiment of a component of a presently preferred embodiment of the invention;

FIG. 3 is an elevated perspective view of components of a presently preferred embodiment illustrating use thereof;

FIG. 4 is an elevated perspective view of a portion of an alternative embodiment of a component of the present invention;

FIG. 5A is a schematic diagram of components of an embodiment of the present invention; and

FIG. 5B is a schematic diagram of a detail of a components shown in FIG. 5A.

### DETAILED DESCRIPTION OF THE PREFERRED EMBODIMENTS

Reference now will be made in detail to the presently preferred embodiments of the invention, one or more examples of which are illustrated in the accompanying drawings. Each example is provided by way of explanation of the invention, which is not restricted to the specifics of the examples. In fact, it will be apparent to those skilled in the art that various modifications and variations can be made in the present invention without departing from the scope or spirit of the invention. For instance, features illustrated or described as part of one embodiment, can be used on another embodiment to yield a still further embodiment. Thus, it is intended that the present invention cover such modifications and variations as come within the scope of the appended claims and their equivalents. The same numerals are assigned to the same components throughout the drawings and description.

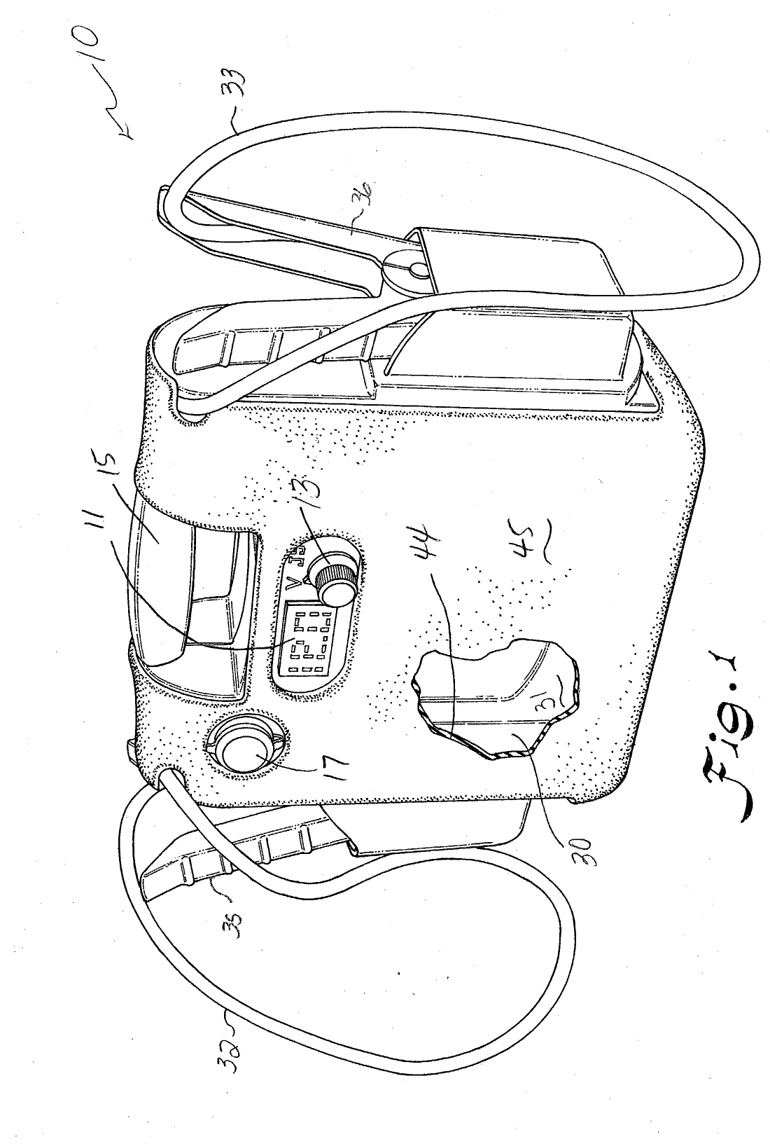

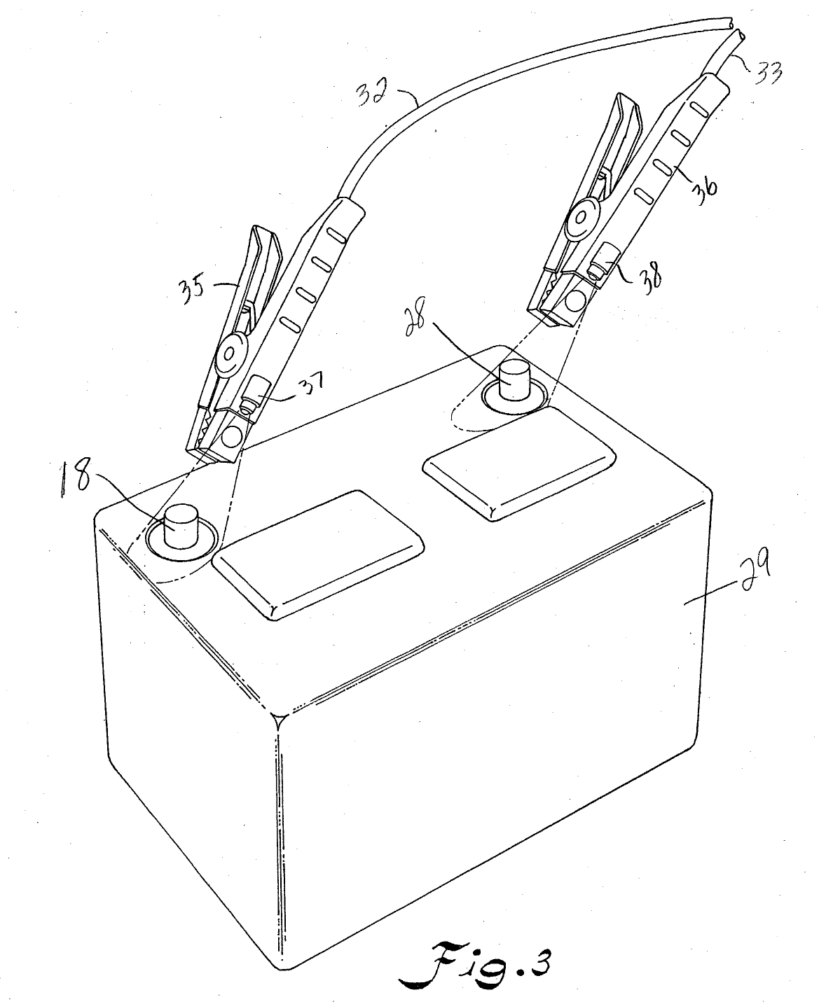

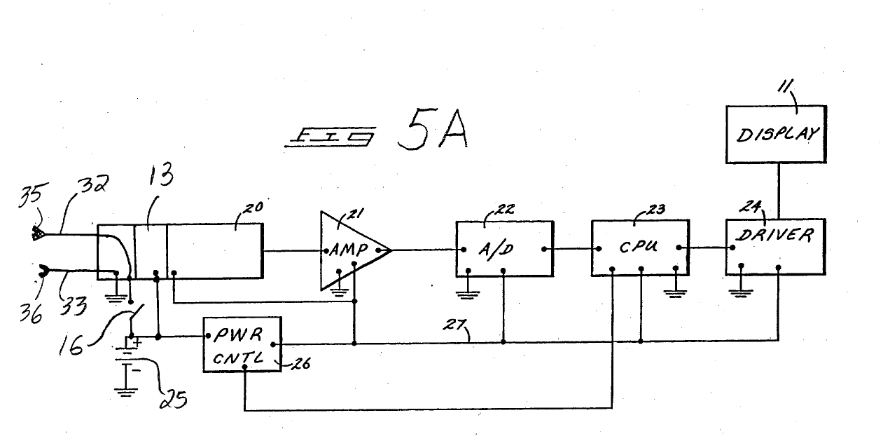

A presently preferred embodiment of the portable, direct current, power supply of the present invention is shown in FIG. 1 and is represented generally by the numeral 10. The portable direct current power supply 10 is suitable for being connected to the terminals 27, 28 of an electrical device such as a vehicle's battery 29 shown in FIG. 3 for example. As shown in FIG. 1 for example, the power supply 10 comprises a case 30 that includes a carrying handle 15 at one end thereof. The case 30 defines an exterior surface 31 and defines a hollow interior space. A direct current battery is surrounded by the case 30 and is disposed within the hollow interior space of the case 30. As is conventional and shown schematically in FIG. 5A for example, the battery 25 inside the case 30 of the power supply 10 has a positive terminal and a negative terminal.

A first electric cable 32 has a first end that is electrically connected to one of the terminals of the battery that is disposed inside the case 30 and a second end that is on the opposite end of the cable 32. A second electric cable 33 is electrically connected to the other one of the terminals of the battery that is disposed inside the case 30 and a second end that is on the opposite end of the cable 32. Each cable 32, 33 is electrically conducting and covered by a sheath formed of electrically-insulating material.

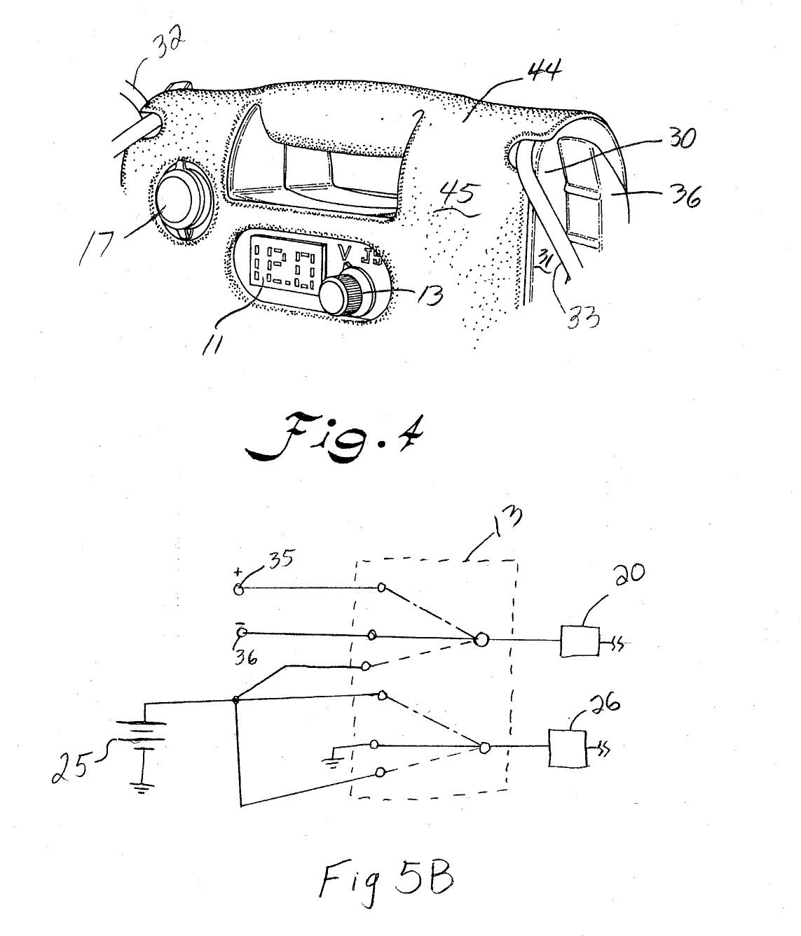

As schematically shown in FIG. 5A for example, the battery 25 inside the case 30 of the power supply 10 is electrically isolated from the power cables 32, 33 by a power switch 16. As shown in FIGS. 1 and 4 for example, a power indicator lamp 17 is provided and configured so as to illuminate when the switch 16 (not shown in FIGS. 1 and 4) is activated to connect the battery 25 (not shown in FIGS. 1 and 4) to the cables 32, 33.

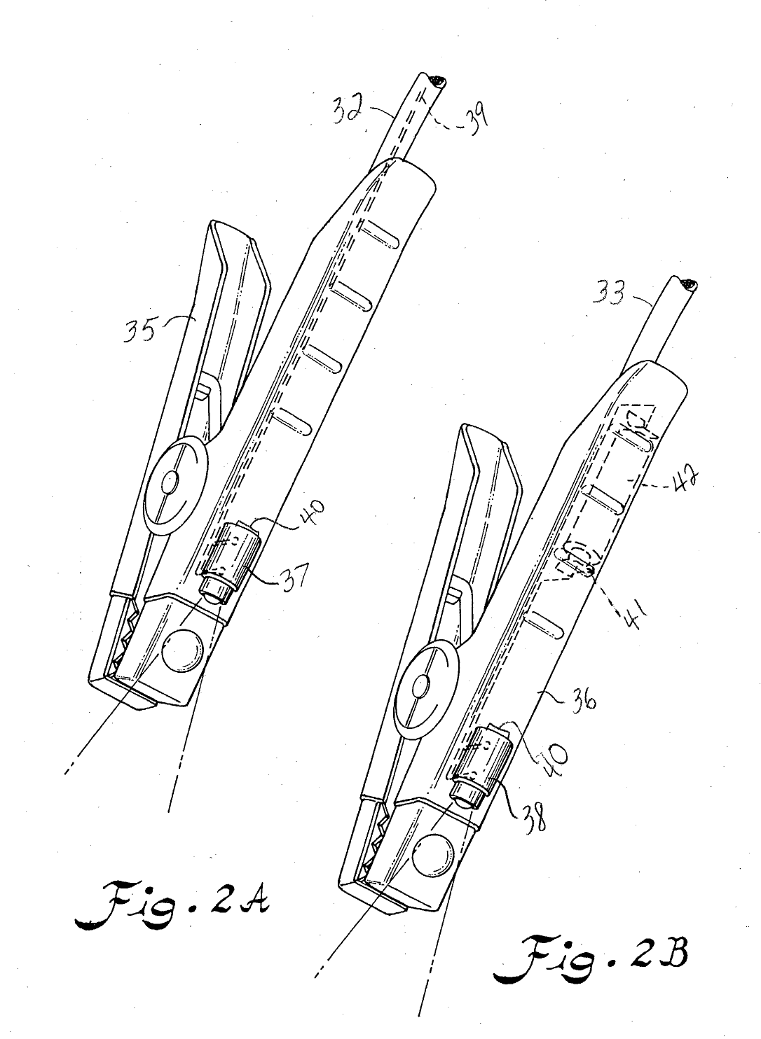

The power supply 30 includes a pair of manually detachable electric connectors. As shown in FIG. 2A for example, a first manually detachable electric connector 35 has a feed end electrically connected to the second end of the first cable 32 and has a gripping end disposed opposite the feed end. The gripping end of the first connector 35 is desirably configured with resiliently opposed alligator jaws to detachably grip at least one of the terminals of the electric device that is to be powered. A second manually detachable electric connector 36 has a feed end that is electrically connected to the second end of the second cable 33 and has a gripping end disposed opposite the feed end. The gripping end of the second connector 36 is desirably configured with resiliently opposed alligator jaws to detachably grip at least one of the terminals of the electric device that is to be powered.

In accordance with the present invention, each of the connectors carries a light source that is disposed thereon so as to illuminate beyond the free end of the connector. As embodied herein and shown in FIG. 2A for example, a first light source 37 is carried by the first connector 35 and disposed thereon so as to illuminate beyond the free end of the first connector 35. As embodied herein and shown in FIG. 2B for example, a second light source 38 is carried by the second connector 36 and disposed thereon so as to illuminate beyond the free end of the second connector 36. Each light source 37, 38 desirably includes a light-emitting diode from which light is emitted. Light-emitting diodes are bright and do not consume a great deal of power for their operation.

As shown in FIG. 2A for example, each light source 37 can be electrically connected so as to be powered by the battery inside the case 30. Electrically conducting wire 39 desirably is threaded inside the sheath surrounding the cable 32 and connects the light source 37 to the battery inside the case 30 (not shown). A switch 40 can be manually operated to turn the light source on and off. In an alternative embodiment shown in FIG. 2B for example, a separate small battery receptacle 41 can be provided and carried on each connector to receive a small battery, such as a triple A battery 42, to power each light source. In yet another alternative embodiment, one light source 37 on one connector 35 can be powered by the battery inside the case 30 while the light source 38 on the other connecter 36 can be powered by a small battery 42 carried by the connector 36.

In further accordance with the present invention, the power supply includes a dual-function, digital read-out voltage meter that is carried by the case 30. The voltage-detection circuit 20, i.e., voltmeter 20, may comprise a resistive voltage divider network or alternatively a potential transformer. The operator can select whether the voltage-detection circuit 20 is electrically connected to the terminals of the battery that is disposed inside the case 30. The digital read-out voltage meter 20 can also be selectively, electrically connected to detect the voltage across the connectors 35, 36 at the respective ends of the cables 32, 33. A switch 13 is desirably carried by the case 30 and electrically connected to control activation of the voltage meter 20. The switch 13 is configured and electrically connected so that the operator can manually operate the switch to select between the numerical display indicating the voltage output of the battery 25 inside the case 30 or the voltage output of the electrical device that is connected to the battery 25 inside the case 30 by the cables 32, 33 and connectors 35, 36.

As embodied herein and shown in FIG. 1 for example, a digital read-out voltage meter 20 is connected to a back-lit, liquid crystal display 11. FIGS. 5A and 5B schematically illustrate one example of a voltmeter 20 connected to an electronically operated numerical display 11, which is housed within the case (not shown). The display 11 can form the front wall of the voltmeter 20. Display 11 is operable to present a digital or numerical display indicative of voltage. Display 11 can comprise a suitable number of conventional seven segment liquid crystal displays (LCD) or light emitting diodes (LED) or any similar electronic numerical displays.

A manual switch 13 is provided at the exterior of the case to initiate operation of the voltmeter circuitry for purposes to be described below. As shown schematically in FIG. 5B for example, switch 13 can be a manually rotatable, three-way toggle switch, as shown, with settings for “off,” “power supply voltage” and “device voltage.” Switch 13 desirably is of a type having dual connecting arms that move together. Each of the dual connecting arms is represented by a different type of drawn line to schematically indicate when the switch 13 is oriented in one of the three positions. The two solid lines in FIG. 5B schematically show the switch 13 in the “off” position during which the voltmeter is not functioning. The two dashed lines in FIG. 5B schematically show the switch 13 in the “power supply voltage” position during which the voltmeter is measuring the voltage output of the battery 25 that is contained inside the case 30 of the power supply 10. The two chain-dashed lines in FIG. 5B schematically show the switch 13 in the “device voltage” position during which the voltmeter is measuring the voltage output of the device to which the power supply will later (or previously) be connected by the connectors 35, 36.

Electronic voltage-responsive means (shown as circuit elements 20 through 24 in FIG. 5A) are provided within the case 30. They are operably connected to the display 11 for producing, when powered, a numerical presentation on the display 11 corresponding to the selected voltage according to the user's orientation of switch 13. The voltmeter 20 is physically located within the case 30. The analog output signal of voltmeter 20 can be fed through an amplifier 21 that is operably connected to an analog-to-digital converter circuit shown at 22. The resulting digital signals corresponding to the measured voltage are directed to suitable electronic control means, such as a microprocessor circuit (CPU) 23. The CPU 23 desirably controls operation of a driver circuit 24 that in turn operates the visual display 11 to provide a numerical display of the voltage.

Power for the various electronic circuits is provided desirably from the battery within the case 30. As schematically shown in FIG. 5A for example, control of this power is achieved desirably through a power control circuit 26 that is operated by CPU 23 and an interconnecting power bus 27. All of the described circuit components 20 through 27 are conventional and located within the confines of the previously described case 30.

Because of its portable nature and relatively small size, the circuitry within the case 30 of the power supply 10 is desirably designed to use very little power from the battery inside the case 30. In aid of this achievement is the properly programmed operation of the power control circuitry 26 and utilization of the manually operable switch 13. The power control circuit 26 is operably connected between the battery 25, the electronic voltage-responsive circuits comprised of circuits 20 through 24, and the display 11. The power control circuit 26 desirably can be configured so as to be electronically shiftable between a two states in which operation of the voltmeter display circuits 20 through 24 and display 11 are powered and a third state in which they are inoperative. The manually operable switch 13 at the exterior of the case is operably connected to the power control circuit 26 for selectively causing the power control circuit 26 to be shifted to its first state or second states when the switch 13 is actuated by the user to assume one of the “power supply voltage” and “device voltage” positions that are schematically shown in FIG. 5B as described above.

To minimize battery operation, the CPU 23 is preferably programmed to cause the power control circuit 26 to be shifted to its third state, which is the “off” position of switch 13, following a first predetermined time period after actuation of switch 13 by the user. A typical first time period is five seconds.

The digitized signal that is indicative of the operator-selected voltage reading is then detectable by the programmed CPU 23 to maintain power control circuit 26 in an active state for a second time period adequate to assure observation of the voltage while the display 11 is in communication with either the battery 25 or the device that is to be charged or powered by the power supply 10. A typical period for this watchdog timer function is ten seconds. Finally, CPU 23 can be programmed to time operation of power control circuit 26 for a third time period, typically five seconds, after the sensed voltage has returned to a zero value following disconnection of the voltmeter by turning switch 13 to the “off” position. This provides time for a user to subsequently read the numerical information presented on display 11. The progression of time periods, which normally overlap one another, assures normal voltage measurement operation while minimizing battery usage even under circumstances where internal components of the voltmeter and display circuitry might be momentarily inoperative or operate improperly.

In still further accordance with the present invention, the power supply further desirably includes an elastomeric cover that overlies the exterior surface of the case. As embodied herein and shown in FIG. 1 for example, the cover 44 desirably overlies substantially the entire exterior surface 31 of the case 30. However, the cover 44 is desirably provided with cutouts for the switches (e.g., switch 13), power indicator light 17 and display 11. The cover 44 is desirably formed of shock-absorbing rubber and is configured with sufficient thickness to cushion the case 30 from mechanical shocks to the case. The cover 44 can be provided with fasteners (not shown) so that it is selectively removable from the case 30 so as to permit changing of the battery 25 carried within the case. Alternatively, the cover 44 can be permanently molded onto the exterior surface 31 of the case 30.

The cover 44 desirably includes a skid-resistant surface 45 that is configured and disposed for resting the power supply on foreign objects. For example, surface 45 could have a roughened exterior for better traction. In an alternative embodiment shown in FIG. 4 for example, cover 44 is configured to wrap around the carrying handle of the case 30. Though not shown, portions of the surface 45 of the cover 44 can be molded to carry the logo or other identifying information indicating the manufacturer or distributor of the power supply 10.

Build soft rubber that goes over the whole unit that leaves a hole for the gauge. Impact resistance and non-skid capabilities and trade dress molded into the rubber.

While a preferred embodiment of the invention has been described using specific terms, such description is for illustrative purposes only, and it is to be understood that changes and variations may be made without departing from the spirit or scope of the following claims.

1. A portable direct current power supply for being connected to the terminals of an electrical device, comprising:
a case defining an exterior surface and a hollow interior space;
a battery disposed within said interior space of said case, said battery having a positive terminal and a negative terminal;
a first cable having a first end and a second end disposed opposite said first end, said cable being electrically conducting and covered by a sheath formed of electrically-insulating material, said first end of said first cable being electrically connected to one of said terminals of said battery;
a second cable having a first end and a second end disposed opposite said first end, said second cable being electrically conducting and covered by a sheath formed of electrically-insulating material, said first end of said second cable being electrically connected to the other one of said terminals of said battery;
a first manually detachable electric connector having a feed end electrically connected to said second end of said first cable and having a gripping end disposed opposite said feed end and configured to detachably grip at least one of the terminals of the electric device that is to be powered;
a second manually detachable electric connector having a feed end electrically connected to said second end of said second cable and having a gripping end disposed opposite said feed end and configured to detachably grip at least one of the terminals of the electric device that is to be powered; and
a first light source carried by said first connector and disposed thereon so as to illuminate beyond the gripping end of said first connector.

2. A power supply as in claim 1, wherein said first light source includes a light-emitting diode.

3. A power supply as in claim 1, wherein said first light source is electrically connected so as to be powered by said battery.

4. A power supply as in claim 1, further comprising:
a battery receptacle configured to receive therein a small battery, said battery receptacle being carried by said first connector and electrically connected to said first light source so that said first light source can be powered by a small battery received in said battery receptacle.

5. A power supply as in claim 1, further comprising:
a second light source carried by said second connector and disposed thereon so as to illuminate beyond the gripping end of said second connector.

6. A power supply as in claim 1, further comprising:
an elastomeric cover overlying said exterior surface of said case and configured to cushion said case from mechanical shocks to said case.

7. A power supply as in claim 6, wherein said cover includes a skid-resistant surface that is configured and disposed for resting the power supply on foreign objects.

8. A power supply as in claim 6, wherein said cover is selectively removable from said exterior surface of said case.

9. A power supply as in claim 6, wherein said cover is permanently molded to said exterior surface of said case.

10. A power supply as in claim 6, wherein said cover is formed of rubber.

11. A portable direct current power supply for being connected to the terminals of an electrical device, comprising:
a case defining a hollow interior space;
a battery disposed within said interior space of said case, said battery having a positive terminal and a negative terminal;
a first cable having a first end and a second end disposed opposite said first end, said cable being electrically conducting and covered by a sheath formed of electrically-insulating material, said first end of said first cable being electrically connected to one of said terminals of said battery;
a second cable having a first end and a second end disposed opposite said first end, said second cable being electrically conducting and covered by a sheath formed of electrically-insulating material, said first end of said second cable being electrically connected to the other one of said terminals of said battery;
a first manually detachable electric connector having a feed end electrically connected to said second end of said first cable and having a gripping end disposed opposite said feed end and configured to detachably grip at least one of the terminals of the electric device that is to be powered;
a second manually detachable electric connector having a feed end electrically connected to said second end of said second cable and having a gripping end disposed opposite said feed end and configured to detachably grip at least one of the terminals of the electric device that is to be powered; and
a digital read-out voltage meter carried by said case and electrically connected to said terminals of said battery so as to provide a numerical display that indicates the voltage output of said battery.

12. A power supply as in claim 11, wherein said digital read-out voltage meter includes a back-lit, liquid crystal display.

13. A power supply as in claim 11, further comprising:
a switch carried by said case and electrically connected to control activation of said digital read-out voltage meter.

14. A power supply as in claim 13, wherein said digital read-out voltage meter and said switch are electrically connected so as to selectively provide one of a numerical display that indicates the voltage output of said battery and a numerical display that indicates the voltage output of the electrical device.

15. A power supply as in claim 1, further comprising:
an elastomeric cover overlying said exterior surface of said case and configured to cushion said case from mechanical shocks to said case.

16. A power supply as in claim 15, wherein said cover includes a skid-resistant surface that is configured and disposed for resting the power supply on foreign objects.

17. A power supply as in claim 15, wherein said cover is selectively removable from said exterior surface of said case.

18. A power supply as in claim 15, wherein said cover is permanently molded to said exterior surface of said case.

19. A power supply as in claim 15, wherein said cover is formed of rubber.

20. A portable direct current power supply for being connected to the terminals of an electrical device, comprising:
a case defining an exterior surface and a hollow interior space;
a battery disposed within said interior space of said case, said battery having a positive terminal and a negative terminal;
a first cable having a first end and a second end disposed opposite said first end, said cable being electrically conducting and covered by a sheath formed of electrically-insulating material, said first end of said first cable being electrically connected to one of said terminals of said battery;
a second cable having a first end and a second end disposed opposite said first end, said second cable being electrically conducting and covered by a sheath formed of electrically-insulating material, said first end of said second cable being electrically connected to the other one of said terminals of said battery;
a first manually detachable electric connector having a feed end electrically connected to said second end of said first cable and having a gripping end disposed opposite said feed end and configured to detachably grip at least one of the terminals of the electric device that is to be powered;
a second manually detachable electric connector having a feed end electrically connected to said second end of said second cable and having a gripping end disposed opposite said feed end and configured to detachably grip at least one of the terminals of the electric device that is to be powered;
a first light source including a first light-emitting diode carried by said first connector and disposed thereon so as to illuminate beyond the gripping end of said first connector wherein said light source is electrically connected so as to be powered by said battery;
a second light source including a second light-emitting diode carried by said second connector and disposed thereon so as to illuminate beyond the gripping end of said second connector;
a battery receptacle configured to receive therein a small battery, said battery receptacle being carried by said second connector and electrically connected to said second light source so that said second light source can be powered by a small battery received in said battery receptacle;
a digital read-out voltage meter carried by said case and electrically connected to said terminals of said battery so as to provide a numerical display that indicates the voltage output of said battery, said digital read-out voltage meter including a back-lit, liquid crystal display;
a switch carried by said case and electrically connected to control activation of said digital read-out voltage meter wherein said digital read-out voltage meter and said switch are electrically connected so as to selectively provide one of a numerical display that indicates the voltage output of said battery and a numerical display that indicates the voltage output of the electrical device; and
an elastomeric cover overlying and permanently molded to said exterior surface of said case and configured to cushion said case from mechanical shocks to said case, said cover including a skid-resistant surface that is configured and disposed for resting the power supply on foreign objects.
